(19) United States
(12) Patent Application Publication
(10) Pub. No.: US 2008/0149040 A1
(43) Pub. Date: Jun. 26, 2008

(54) FEED DOOR FOR LIVESTOCK TRAILER

(76) Inventors: Wanda Welchel, Oklahoma City, OK (US); John A. Beam, Oklahoma City, OK (US); Gilberto Orozco, Oklahoma City, OK (US); Vladimir Yun, Oklahoma City, OK (US)

Correspondence Address: DUNLAP CODDING & ROGERS, P.C., PO BOX 16370, OKLAHOMA CITY, OK, 73113, US

(21) Appl. No.: 11/868,798

(22) Filed: Oct. 8, 2007

Related U.S. Application Data
(60) Provisional application No. 60/850,118, filed on Oct. 6, 2006.

(51) Int. Cl. B60P 3/04; A01K 5/00

(52) U.S. Cl. 119/408

(57) ABSTRACT

A drop down feed door for a trailer having a sidewall with a trailer frame defining a trailer access opening. The feed door including a frame assembly adapted to be hinged to the sidewall of the trailer and a window assembly having a window frame and a light transmitting pane supported by the window frame. The window frame having a flange and the window assembly positioned in the window receiving opening of the frame assembly with the flange of the window assembly overlapping one side of the frame assembly along the circumference of the window receiving opening. A connecting member is connected to the window frame of the window assembly and extended over an adjacent portion of the frame assembly so as to secure the window assembly within the window receiving opening of the frame assembly.

### CROSS-REFERENCE TO RELATED APPLICATIONS

This application claims benefit of U.S. Provisional Application No. 60/850,118, filed Oct. 6, 2006, which is hereby incorporated herein by reference in its entirety.

### BACKGROUND OF THE INVENTION

1. Field of the Invention

The present invention relates to livestock trailers, and more particularly but not by way of limitation, to an improved feed door for a livestock trailer.

2. Brief Description of Related Art

Livestock, such as horses, are often transported from one location to another in specially constructed trailers which include side walls and a roof, and are generally formed with one or more gates or doors at the rear end of the trailer to permit horses to be loaded and unloaded and several windows, also known as “drop down feed doors,” along the sidewall of the trailer where the head end of the horses will be positioned to facilitate watering and feeding of the horses while the horses remain in the trailer. Such trailers are usually towed behind motorized vehicles, and it is often desirable or necessary to transport the animals over long distances.

Drop down feed doors typically include a rigid frame that is hinged to a corresponding frame secured within the sidewall of the trailer so that the rigid frame is movable between a closed position wherein the frame is seated in the trailer frame and an open position wherein the frame is pivoted outwardly and downwardly in a substantially parallel relationship with the sidewall of the trailer. The rigid frame defines an opening in which a window assembly is supported. A skin or composite layer, which typically comprises two parallel sheets of material, such as aluminum or fiberglass, spaced by a foam backing, is extended between the outer edge of the window assembly and the rigid frame. An opening is cut out of the composite layer to receive the window assembly. The window assembly is positioned in the opening and secured to the composite layer.

This method of manufacturing drop down feed doors has several disadvantages. First, the process requires the assembly of the rigid frame and the composite layer, thereby increasing materials and labor costs. Next, because the composite layer is employed, the size of the window assembly that may be utilized in the drop down feed door is limited.

### BRIEF DESCRIPTION OF THE DRAWINGS

FIG. 1 is a fragmental, side elevational view of a livestock trailer shown with a plurality of feed doors constructed in accordance with the present invention.

FIG. 2 is a fragmental elevational view of the trailer shown with feed door in an open position and a cage assembly in a closed position.

FIG. 3 is an elevational view of a frame assembly of the feed door.

FIG. 3A a cross-sectional view of the frame assembly of FIG. 3 taken along the line of 3A-3A thereof.

FIG. 4 is is an elevational view of the frame assembly showing the frame assembly shaped to receive a window assembly.

FIG. 4A is a fragmental sectional view showing the window assembly secured to the frame assembly.

FIG. 5 is a front elevational view showing the feed door shown in an open position and the cage assembly in an open position.

FIG. 6 is a rear elevational view of the cage assembly.

FIG. 7 is a side elevational view of the cage assembly.

FIG. 8 is a top plan view of the cage assembly.

FIG. 9 is a side elevational view of the cage assembly shown rotated 90 degrees to a horizontal position.

FIG. 10 is a side elevational view of the cage assembly shown in an extended position.

FIG. 11 is a side elevational view of the cage assembly shown rotated downwardly to a vertical position.

FIG. 12 is a side elevational view of a bearing member.

FIG. 13 is a cross-sectional view of the bearing member of FIG. 12 taken along line 13-13 thereof.

### DETAILED DESCRIPTION OF EXEMPLARY EMBODIMENTS

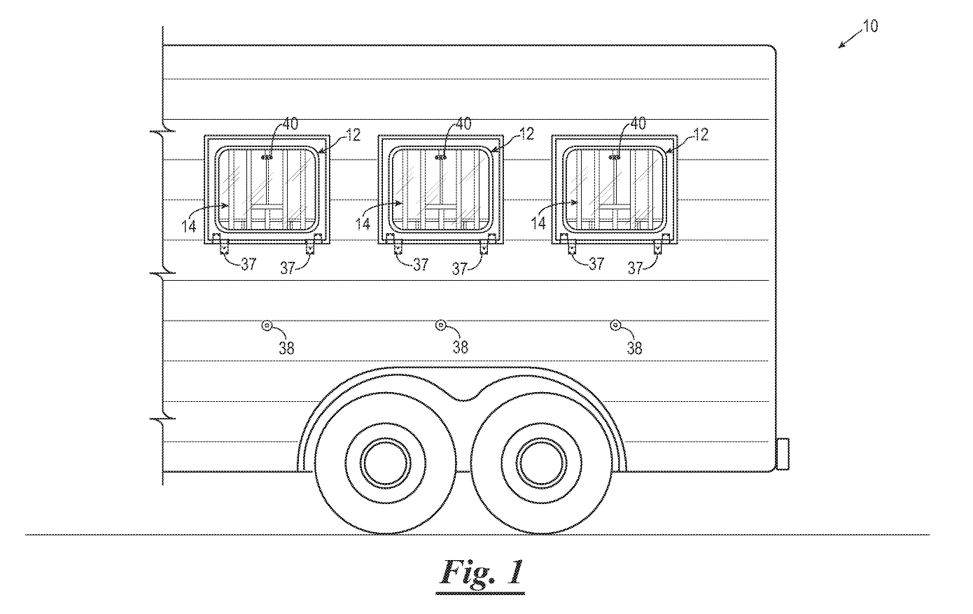

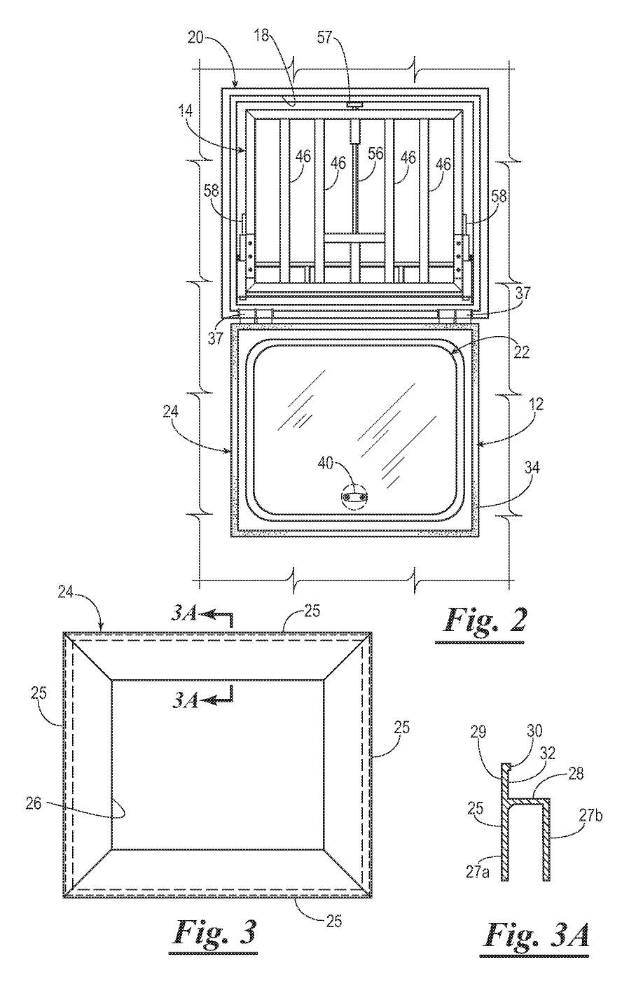

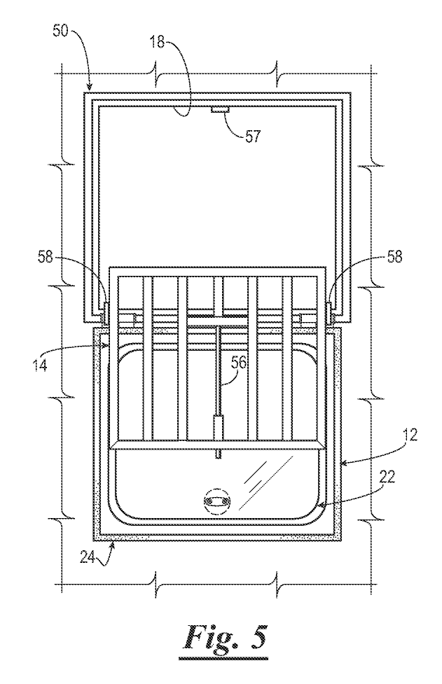

Referring now to the drawings, and more particularly to FIGS. 1, 2, and 5, shown therein is a livestock trailer 10 having a plurality of feed doors 12 and corresponding cage assemblies 14. Each of the feed doors 12 is disposed in a window opening 18 defined by a trailer frame 20 and is pivotally connected to the trailer frame 20, which is secured in the sidewall of the trailer 10 (FIG. 2), such that the feed door 12 can be selectively moved between an up or closed position, substantially as shown in FIG. 1, and a down or open position, substantially as shown in FIG. 2. Likewise, the cage assembly 14 is disposed in the window opening 18 defined by the trailer frame 20 and is pivotally connected to the trailer frame 20 such that the cage assembly 14 can be selectively moved between an up or closed position, substantially as shown in FIG. 2, and a down or open position, substantially as shown in FIG. 5.

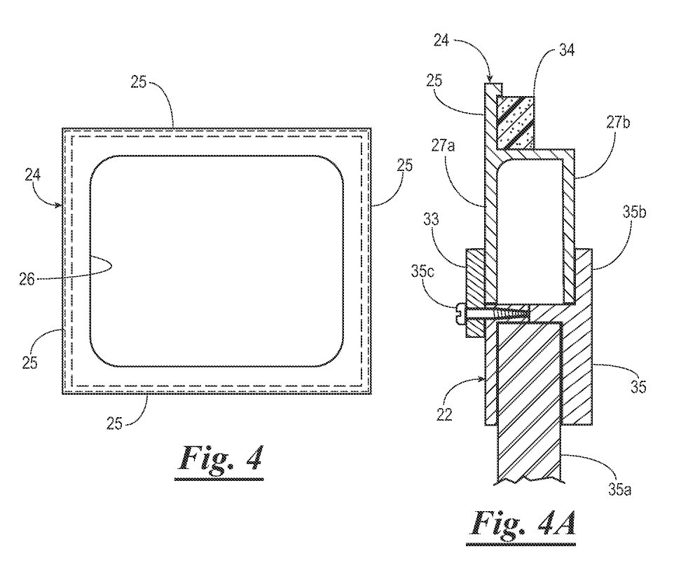

The feed door 12, shown in FIG. 2, includes a window assembly 22 and a frame assembly 24. The frame assembly 24 of the feed door 12, as best shown in FIG. 3, is constructed from a plurality of extruded rails 25 interconnected to one another to define a window receiving opening 26 (FIG. 3). As best shown in FIG. 3A, the rails 25 have a lower-case h-shape so as to define a pair of inner legs arranged in a spaced apart, parallel relationship to one another and a single outer leg extending in an opposing direction to the inner legs. The rails 25 are interconnected together in a suitable fashion, such as by welding, to form the frame assembly 24. The rails 25 have a knee-like portion 28 created by the two legs 27a and 27b extending therefrom and a lip 30 on the tip of the single leg 29 pointing in the direction of the knee-like portion 28. An inset 32 is created between the knee-like portion 28 and the lip 30 on the tip of the single leg where a sealing member 34 (FIGS. 2 and 4A) is positioned that extends the entire circumference of the frame assembly 24 of the feed door 12 and provides a seal against the trailer frame 20 when the feed door 12 is in the up or closed position. The rails 25 are bonded together such that the two legs 27a and 27b are extending toward the inside of the frame assembly 24 and the single leg 29 is extending outwardly to create the outside of the frame assembly 24. The rails 25 may be constructed of any suitable material such as aluminum, steel, carbon fiber, carbon composite, polymer, or any other metal or material known by one of ordinary skill in the art and commercially available.

Either before or after the rails 25 are interconnected together to form the frame assembly 24, the distal ends of the inner legs 27a and 27b are cut or otherwise shaped or manipulated to conform to the size and contour of the perimeter of the window assembly 22, such as illustrated in FIG. 4 where the window receiving opening 31 has been enlarged and the corners rounded, to allow for the window assembly 22 to be set within the frame assembly 24. The rails 25 may be manipulated by any method of cutting metal that is known in the art to allow for the window assembly 22 to be set into the frame assembly 24.

Once the rails 25 are connected together and sized and shaped as desired, the window assembly 22 is set inside the frame assembly 24 of the window assembly 12. The window assembly 22 may be any window assembly that includes an outer window frame 35 supporting a light transmissive pane 35a. The window frame 35 typically includes a flange 35b extending from one side of the window frame 35. Window assemblies which are manufacture for installation in trailers, such as window assembly 22, are well know in the art. A suitable window assembly is model no. 4623193623, manufactured by State Wide Aluminum, Inc. of Elkart, Ind. Thus, no further description of such window portions is deemed necessary for one of ordinary skilled in the art to understand the invention and the inventive concepts set forth herein.

As shown in FIG. 4A, the window assembly 22 is inserted directly into the window receiving opening 26 of the frame assembly 24 with the flange 35b of the window assembly 22 overlapping at least a portion of an outer facing surface of the inner leg 27b. The window assembly 22 is secured directly to the frame assembly 24 using a connecting member 33, such as a metal band. The connecting member 33 is positioned so that the connecting member 33 overlaps at least a portion an on outer facing surface of the inner leg 27a and a portion of the window frame 35 of the window assembly. The connecting member 33 is secured to a portion of the window frame 35 of the window assembly 22 with a suitable fastener 35c, such as a screw or rivet.

The window assembly 22, shown in FIG. 2, includes a latch mechanism (not shown) to secure the feed door 12 in the closed position and selectively permit the feed door 12 to be moved to the open position wherein the feed door 12 is positioned substantially parallel to the side wall of the trailer 10. Such latch release mechanisms are well known in the art. Thus, no further description of such latch release mechanisms are necessary for one of ordinary skilled in the art to understand the invention and the inventive concepts set forth herein.

The feed door 12 is attached to the external side of the livestock trailer 10 frame by a pair of hinge assemblies 37 (FIGS. 1 and 2). More specifically, the frame assembly 24 of the feed door 12 is preferably attached to a lower part of the livestock trailer frame 20 to allow the feed door 12 to pivot outward and downward. However, it should be understood that the feed door 12 may be secured in any location on the trailer frame 20 to permit the feed door 12 to be pivoted in any desired direction.

The feed door 12 further includes a connector assembly for securing the feed door 12 in the open or down position adjacent the external side of the trailer 10. The connector assembly as shown includes a female member 38 (FIG. 1) on the side of the livestock trailer 10 and a male member 40 on the feed door 12 which are adapted to matingly engage when the feed door 12 is in the down position, thereby securing the feed door 12 in a stable position adjacent the exterior side of the trailer 10.

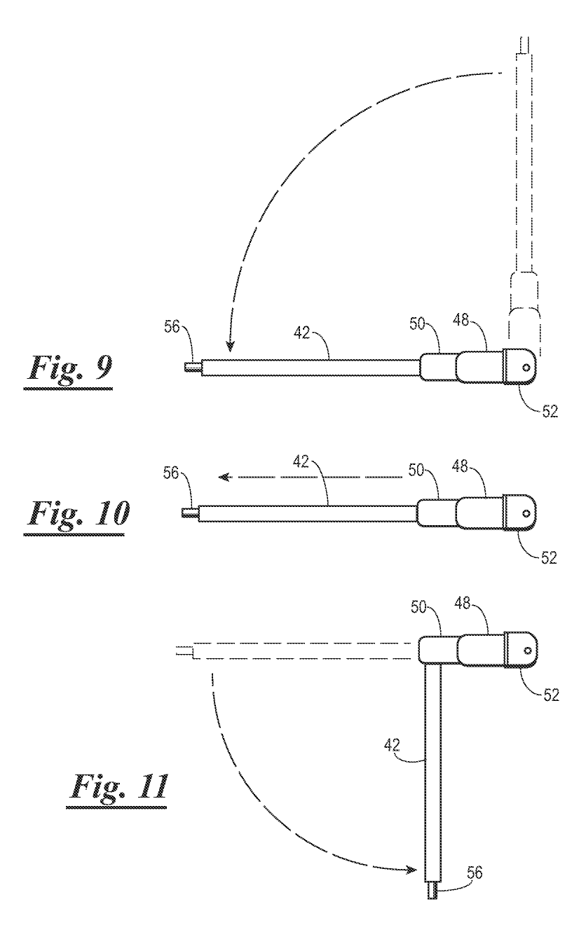

Referring now to FIGS. 1, 2, 5-12, the cage assemblies 14 are positioned inwardly from a respective feed door 12 and pivotally connected to the trailer frame 20. The cage assemblies 14 permit air to enter into the trailer 10 and circulate through the trailer 10 when the corresponding feed door 12 is in the open position and is configured to prevent livestock from sticking their head outwardly through the window opening 18. More specifically, each of the cage assemblies 14 is adapted to be pivotally connected to an internal side of the trailer frame 20 defining the window opening 18 such that the cage assembly 14 is selectively moveable between a first position wherein the cage assembly 14 is secured within the window opening 18 substantially as shown in FIG. 2, to a second position wherein the cage assembly 14 is rotated approximately 90° to a second or extended position wherein the cage assembly 14 is disposed substantially perpendicular to the window opening (FIG. 9) and which is selectively moved to an extended position for permitting rotation whereby the cage assembly 14 can be rotated approximately an additional 90° to a third or down position wherein the cage assembly 14 is disposed substantially parallel to its corresponding feed door 12, substantially as shown in FIGS. 5 and 11. However, it should be appreciated that the cage assemblies 14 may be adapted to be pivotally connected to an external side of the trailer frame 20 in a manner well known in the art.

Referring now to FIGS. 5, 6, and 7, the window cage assembly 14 is illustrated as having a cage 42 slidably and pivotally connected to a support assembly 44 for connecting the cage 42 of the cage assembly 14 to a portion of the trailer 10 defining the window opening 18 thereof. The cage 42 includes a frame 45 and plurality of bars 46 secured within an opening defined by the frame 45 so that air can readily pass there through while at the same time preventing livestock from sticking their head through the cage assembly 14 when the cage assembly 14 is in the position substantially as shown in FIG. 2. The support assembly 44 includes bearing housings 48 supported on the ends of a plurality of rods 49. Each of the bearing housings 48 support a bearing member 50 for effecting pivotal and sliding movement of the cage 42 between the first position, the second position and the third position as shown in FIGS. 1, 9, 10, and 11, in a manner to be described below. The support assembly 44 is pivotally connected to a bracket 52 which is connected to the internal side of the trailer frame 20.

The cage assembly 14 is further provided with a locking mechanism which includes a slidable rod member 56 biased in an upward position for engaging a latch 57 supported by the trailer frame 20 such that when the cage 42 is disposed within the window opening 18, the rod member 56 engages the latch 57 and secures the cage 42 in a secure position within the window opening 18.

As previously stated, the locking mechanism is biased in the extended position. Thus, the locking mechanism for the cage assembly 14 can be moved to a retracted position whereby the rod member 56 is retracted and disengages the latch 57 so that the cage assembly 14 can be selectively moved to the second position.

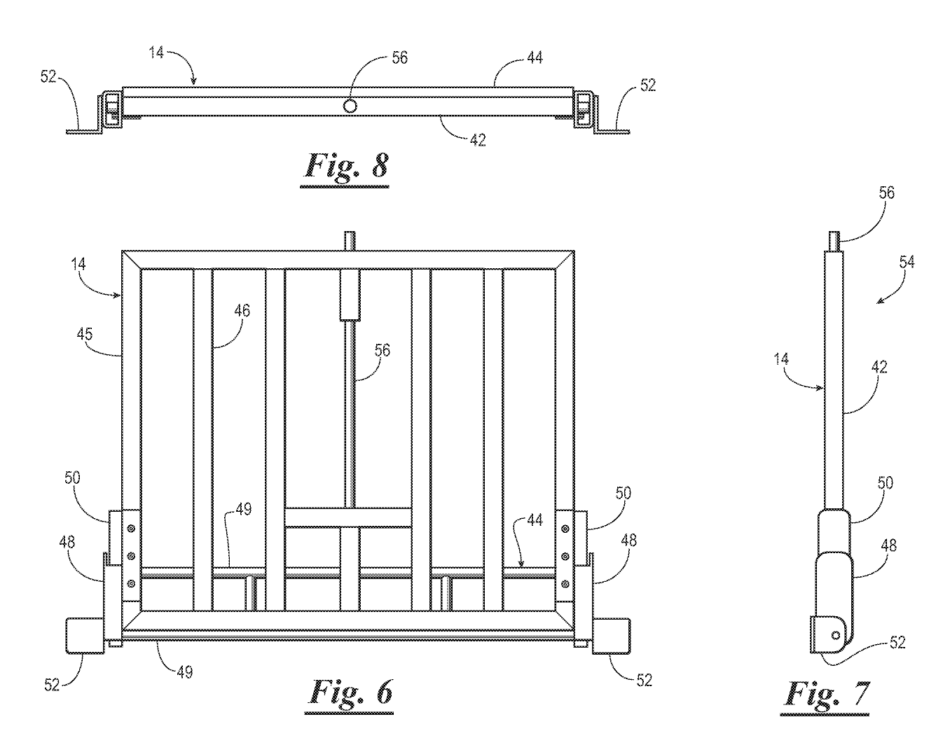

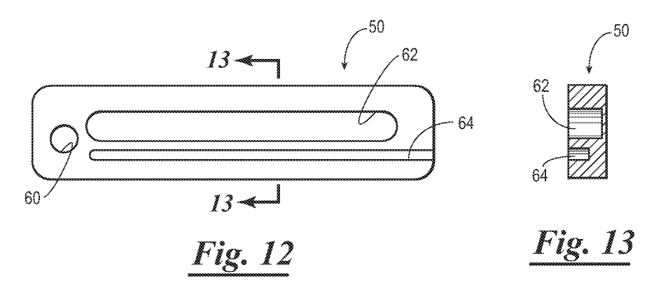

Referring now to FIG. 6, in combination with FIGS. 12 and 13, one of the bearing members 50 of the window cage assembly 14 which permits pivotal and sliding movement of the cage assembly 14 between the first, second and third positions is shown. Because the bearing members 50 are similar in construction and substantially mirror images of one another, only the bearing member 50 will be described in detail.

As shown in FIG. 12, the bearing member 50 is provided with an aperture 60 for pivotally connecting the bearing housing 48 and the bearing member 50 to the bracket employed to secure the cage to the trailer frame 20 defining the window opening 18. The bearing member 50 can be fabricated of any material which enhances sliding and pivotal movement of the cage between the first, second and third position. However, desirable results have been achieved when the bearing member 50 is fabricated of a polymeric material, such as neoprene.

Referring now to FIGS. 12 and 13, the bearing member 50 is provided with a first slot 62 and a second slot 64. The first slot 62 allows the bearing member 50 to be selectively moved through the bearing housing 48, while the second slot 64 permits the cage to be selectively extended as shown in FIG. 10 so that the cage can be moved between the second or extended position and the third or down position. The cage 42 can be equipped with flanges 58 to permit the cage assembly 14, and more particularly the flanges 58, to be slidably disposed in the second slot 64 of the bearing member 50.

From the above description, it is clear that the present invention is well adapted to carry out the objects and to attain the advantages mentioned herein, as well as those inherent in the invention. While a presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A drop down feed door for a trailer having a sidewall with a trailer frame defining a trailer access opening, the drop down feed door comprising:
a frame assembly adapted to be hinged to the sidewall of the trailer such that the frame assembly is movable between a closed position wherein the frame assembly is seated against the trailer frame and an open position wherein the frame assembly is unseated from the trailer frame, the frame assembly defining a window receiving opening;
a window assembly having a window frame and a light transmitting pane supported by the window frame, the window frame having a flange and the window assembly positioned in the window receiving opening of the frame assembly with the flange of the window assembly overlapping one side of the frame assembly along the circumference of the window receiving opening; and
a connecting member connected to the window frame of the window assembly and extending over an adjacent portion of the frame assembly so as to secure the window assembly within the window receiving opening of the frame assembly.

2. The drop down feed door of claim 1, wherein the frame assembly is constructed of a plurality of rails interconnected to one another to define the window receiving opening, each of the rails having a lower-case h-shape so as to define a pair of inner legs in a spaced apart, parallel relationship to one another and a single outer leg extending in an opposing direction to the inner legs, and wherein the flange of the window frame of the window assembly overlaps at least a portion of an outer facing surface of one of the inner legs.

3. The drop down feed door of claim 2, wherein the connecting member overlaps at least a portion of an outer facing surface of the other inner leg.

4. The drop down feed door of claim 2, wherein a distal end of each of the inner legs is shaped to conform to the contour of the frame of the window assembly.

5. A drop down feed door in combination with a trailer having a sidewall with a trailer frame defining a trailer access opening, the drop down feed door comprising:
a frame assembly hinged to the trailer frame such that the frame assembly is movable between a closed position wherein the frame assembly is seated against the trailer frame and an open position wherein the frame assembly is unseated from the trailer frame, the frame assembly defining a window receiving opening;
a window assembly having a window frame and a light transmitting pane supported by the window frame, the window frame having a flange and the window assembly positioned in the window receiving opening of the frame assembly with the flange of the window assembly overlapping one side of the frame assembly along the circumference of the window receiving opening; and
a connecting member connected to the window frame of the window assembly and extending over an adjacent portion of the frame assembly so as to secure the window assembly within the window receiving opening of the frame assembly.

6. The combination of claim 5, wherein the frame assembly is constructed of a plurality of rails interconnected to one another to define the window receiving opening, each of the rails having a lower-case h-shape so as to define a pair of inner legs in a spaced apart, parallel relationship to one another and a single outer leg extending in an opposing direction to the inner legs, and wherein the flange of the window frame of the window assembly overlaps at least a portion of an outer facing surface of one of the inner legs.

7. The combination of claim 6, wherein the connecting member overlaps at least a portion of an outer facing surface of the other inner leg.

8. The combination of claim 6, wherein a distal end of each of the inner legs is shaped to conform to the contour of the frame of the window assembly.

9. A method of forming a drop down feed door for a trailer, the trailer having a sidewall with a trailer frame defining a window receiving opening, the method comprising:
providing a window assembly having a window frame and a light transmitting pane supported by the window frame, the window frame having a flange;
forming a frame assembly defining a window receiving opening;
inserting window assembly in the window receiving opening of the frame assembly with the flange of the window assembly overlapping one side of the frame assembly along the circumference of the window receiving opening;
securing the window assembly in the window receiving opening of the frame assembly; and
attaching the frame assembly to the trailer frame so that the combination of the frame assembly and the window assembly is pivotal between a closed position wherein the frame assembly is seated against the trailer frame and an open position wherein the combination of the frame assembly and the window portion are positioned substantially adjacent the sidewall of the trailer in a parallel relationship thereto.

10. The method of claim 9, wherein the step of forming the frame assembly further comprises interconnecting a plurality of rails to one another to define the window receiving opening, each of the rails having a lower-case h-shape so as to define a pair of inner legs in a spaced apart, parallel relationship to one another and a single outer leg extending in an opposing direction to the inner legs, and wherein the step of inserting the window assembly in the window receiving opening of the frame assembly further comprises overlapping at least a portion of an outer facing surface of one of the inner legs with the flange of the window frame of the window assembly.

11. The method of claim 10, wherein the step of attaching the window assembly to the frame assembly further comprises positioning a connecting member so that the connecting member overlaps at least a portion of an outer facing surface of the other inner leg and a portion of the window frame of the window assembly and securing the connecting member to the window frame of the window assembly.

12. The method of claim 10 further comprising: shaping a distal end of each of the inner legs to conform to the contour of the window frame of the window assembly.
